(19) United States
(12) Patent Application Publication
(10) Pub. No.: US 2013/0086472 A1
(43) Pub. Date: Apr. 4, 2013

(54) INTERACTIVE TECHNIQUES FOR RECTIFYING AND SCROLLING PHOTOS OF DOCUMENTS IN A 3D VIEWPORT

(71) Applicant: Patrick CHIU, Menlo Park, CA (US)

(72) Inventor: Patrick CHIU, Menlo Park, CA (US)

(73) Assignee: FUJI XEROX CO., LTD., Tokyo (JP)

(21) Appl. No.: 13/252,573

(22) Filed: Oct. 4, 2011

(51) Int. Cl. G06F 3/033; G06F 3/14

(52) U.S. Cl. 715/273

(57) ABSTRACT

Systems and methods for providing a user interface to help users rectify and scroll photos of documents. Systems and methods are based on an approach employing a 3D viewport with multi-touch gestures along with scroll bars. Scrolling a rotated photo in a 3D space exhibits some strange and unexpected behaviors; wherein systems and methods solve these problems using trigonometry in 3D and Newton's Method while being fast enough to support real-time interaction.

### BACKGROUND OF THE INVENTION

1. Field

The exemplary embodiments described herein are directed to systems and methods for capturing images, and more specifically, to systems and methods for capturing images of documents.

2. Related Art

One way to capture images of documents is by using digital cameras or smartphones as shown in FIG. 1. Compared with the results produced by flatbed scanners, these photos of documents suffer from various issues including perspective distortion, warping, uneven lighting, etc.

There exist several systems with interactive or automatic features for rectification of such problems. For example, some digital cameras have a keystone correction feature. While viewing a photo, the user can select a menu command for keystone correction. Such systems automatically detect a set of edges that form trapezoids. The user selects (with arrow buttons) the desired trapezoid edges, and then selects a menu command to perform the correction to rectify the image into a rectangle with perpendicular sides. A new image is created and the original image is also kept.

Other systems utilize numerous corrective functions including a perspective transform, which can be complicated for novice users. The user selects the image, and goes to the menu command for Perspective Transform. Anchor points appear and the user can drag them to the desired locations. The anchor points are coupled in which anchor points on opposite edges move in unison.

### SUMMARY

Certain exemplary embodiments of the invention described here are directed to methods and systems that substantially obviate one or more of the above and other problems associated with related art techniques for image rectification.

Aspects of these exemplary embodiments include a method of manipulating an image containing a document, which may involve creating a three dimensional viewport for the image; upon receipt of a gesture for rectifying the image, rectifying the image according to the gesture; wherein the gesture is received directly on the image.

Other aspects of these exemplary embodiments may further include a method of manipulating an image of a document, which may involve creating a three dimensional viewport for the image of the document; and receiving a command; wherein if the command is for scrolling the image, scrolling the image according to the gesture and correcting for geometric distortion by utilizing a numerical algorithm to solve for a geometric transform during the scrolling.

Further aspects of the exemplary embodiments may further include an apparatus, which may involve a touch display operable to display an image of a document in a three dimensional viewport; and a manipulation module or a processor; wherein upon receipt of a gesture directly on the image displayed on the touch display, the manipulation module or processor manipulates the image according to the gesture.

Additional aspects of the exemplary embodiments will be set forth in part in the description which follows, and in part will be apparent from the description, or may be learned by practice of the exemplary embodiments. Aspects of the exemplary embodiments may be realized and attained by means of the elements and combinations of various elements and aspects particularly pointed out in the following detailed description and the appended claims.

It is to be understood that both the foregoing and the following descriptions are exemplary and explanatory only and are not intended to limit the embodiments or the application thereof in any manner whatsoever.

### BRIEF DESCRIPTION OF THE DRAWINGS

The accompanying drawings, which are incorporated in and constitute a part of this specification exemplify the embodiments and, together with the description, serve to explain and illustrate principles of the exemplary embodiments.

FIG. 1 illustrates an example of taking a photo of a document from an angle.

FIG. 2 illustrates an example of a photo of a document with perspective distortion.

FIGS. 3a to 3c illustrate rectification of a document contained in a photo object in accordance with an exemplary embodiment.

FIGS. 4a and 4b illustrate exemplary gestures that can be used to perform the rectification in accordance with an exemplary embodiment.

FIGS. 5a and 5b illustrates scaling up a document image to make it readable in accordance with an exemplary embodiment.

FIGS. 6a to 6e illustrate a comparison of skewing when an image is scrolled vertically versus correcting for the skewing in accordance with an exemplary embodiment.

FIG. 7 illustrates the photo object of FIG. 3a placed on a center of origin of a coordinate plane in accordance with an exemplary embodiment.

FIG. 8 illustrates a side view of a photo object rotated by angle θ about the y-axis in accordance with an exemplary embodiment.

FIG. 9 illustrates a side view of a photo object which has been rotated by angle θ about the y-axis, and to be rotated by angle −ψ about the x-axis, in accordance with an exemplary embodiment.

FIG. 10 illustrates parameters for computing the initial estimate of the rotation angle from parameters of the photo object in accordance with an exemplary embodiment.

FIGS. 11a to 11c illustrate scrolling an image along the horizontal axis.

FIG. 12 illustrates stretching that may occur by scrolling the image horizontally.

FIG. 13 illustrates exemplary parameters considered from a top view of a photo object in accordance with an exemplary embodiment.

FIG. 14 illustrates photos of slides that have been manipulated by an implementation of an exemplary embodiment.

FIG. 15 illustrates photos of whiteboards that have been manipulated by implementations of an exemplary embodiment.

FIG. 16 illustrates a flowchart of pure 3D viewport, without a separate 2D mode, in accordance with an exemplary embodiment.

FIG. 17 illustrates a flowchart for rendering a 2D image in conjunction with utilizing a 3D viewport mode in accordance with an exemplary embodiment.

FIG. 18 illustrates a flowchart for rectification in a viewport in accordance with an exemplary embodiment.

FIG. 19 is a block diagram that illustrates an embodiment of a computer/server system upon which an embodiment of the inventive methodology may be implemented.

### DETAILED DESCRIPTION OF THE INVENTION

In the following detailed description, reference will be made to the accompanying drawings, in which identical functional elements are designated with like numerals. The aforementioned accompanying drawings show by way of illustration, and not by way of limitation, exemplary embodiments and implementations consistent with principles of the exemplary embodiments. These implementations are described in sufficient detail to enable those skilled in the art to practice the exemplary embodiments and it is to be understood that other implementations may be utilized and that structural changes and/or substitutions of various elements may be made without departing from the scope and spirit of exemplary embodiments. The following detailed description is, therefore, not to be construed in a limited sense. Additionally, the exemplary embodiments as described may be implemented in the form of a software running on a general purpose computer, in the form of a specialized hardware, or combination of software and hardware.

There are several drawbacks in using known methods of interacting with electronic devices to manipulate or correct the images of documents captured or displayed on such devices. For example, related art systems require entering and exiting different modes often with working with images of documents. This not only hampers fluid interaction with the document but also makes the interactions susceptible to mode errors. Control points or control segments utilized in related art systems to manipulate images of documents detract from a clean user interface design. For example, it is difficult to select small targets on touch screens (the “Fat Finger Problem”) such as control points and lines within related art systems. Moreover, using control points and control segments requires excessive operations (e.g., mouse clicking and dragging). Extra images are generated when using such control points and segments, and since high resolution is required for document legibility, the extra images can take up a substantial amount of memory as the size of the photo collection of documents grows.

Although automatic rectification methods do exist in related systems, they require the edges of the bounding rectangle of the document to be visible inside the photo, which is not always the case. Some related art methods are based on detecting lines of text on the page, which would not work well for pictures, diagrams, and handwriting. Hence, even though automatic methods are available in related art systems, there will be occasions when they fail.

To address these problems, exemplary embodiments of the invention utilize several features, 1) the utilization of a three dimensional (3D) viewport for displaying a captured image instead of a standard two dimensional (2D) viewport, 2) the utilization of gestures and multi-touch gestures for performing manipulation/rectification of the captured image within the 3D viewport without utilizing control points or segments, and 3) the utilization of numerical methods (such as Newton's method) within the 3D viewport to correct for distortion of the image without requiring intensive processing power that may not be available for mobile devices. Exemplary embodiments of the invention can thereby support fluid modeless interaction, eliminate control points or segments, and generate a tiny amount of metadata to specify the view of the scene rather than creating a new high resolution image. By employing multi-touch displays and 3D graphics, it is possible for the exemplary embodiments to develop interactive techniques for rectification that are intuitive and fluid. With multi-touch displays, the user can directly manipulate an image object (e.g., a photo of a document) with a rich vocabulary of gestures. By placing the image object in a 3D scene/viewport with a perspective camera rendering mechanism, the user can easily correct for perspective distortions by simply manipulating the image object in the scene within the 3D viewport.

Previous systems utilized two dimensional rectangular viewing regions as viewports in order to perform rectification. However, the manipulation of the object is thereby restricted only along the x and y dimensions. The exemplary embodiments of the invention create a novel three dimensional viewing region for the image of the document as a viewport to allow the user to perform rectification with gestures and multi-touch gestures and permit manipulation in the 3D region. The exemplary embodiments of the invention utilize the x, y, and z dimensions to perform numerical methods that provide rectification while requiring less computational work than the previous systems.

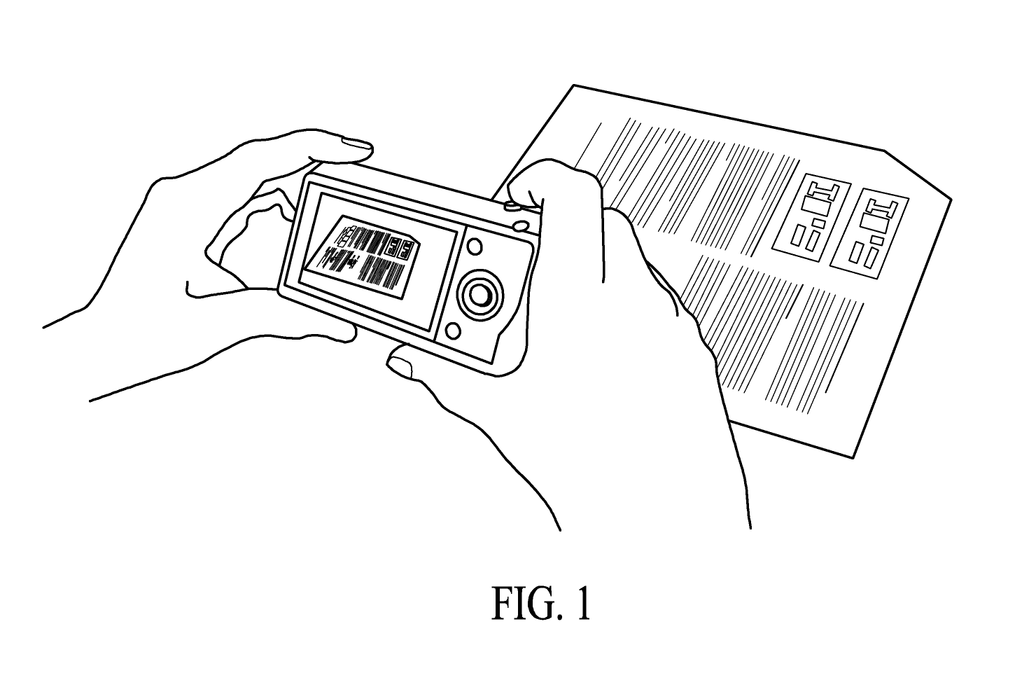

Certain exemplary embodiments attempt rectification by focusing on the problem of perspective distortion (also known as keystone correction). This occurs when the photo of a document is taken at an angle, as shown in FIG. 1. Besides requiring less effort than standing up to take the photo, taking the photo at an angle can help avoid shadows on the document which may occur when the user or camera is directly over it. Other common scenarios where perspective distortion occurs include taking photos of business cards, whiteboards, slides, and signs.

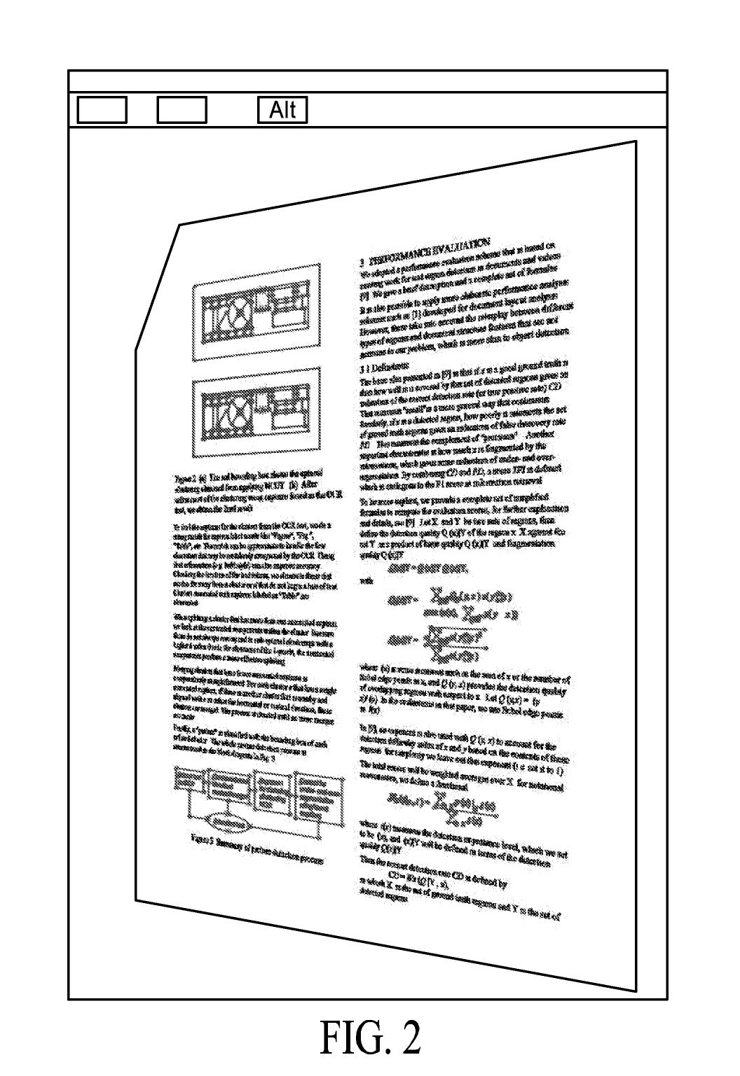

FIG. 2 illustrates an example of a photo of a document with perspective distortion within a graphical user interface (GUI) application in accordance to an exemplary embodiment. This photo illustrated in FIG. 2 was taken in the scenario depicted in FIG. 1. In the center of the GUI application is a 3D viewport that displays a photo of a document in a 3D scene.

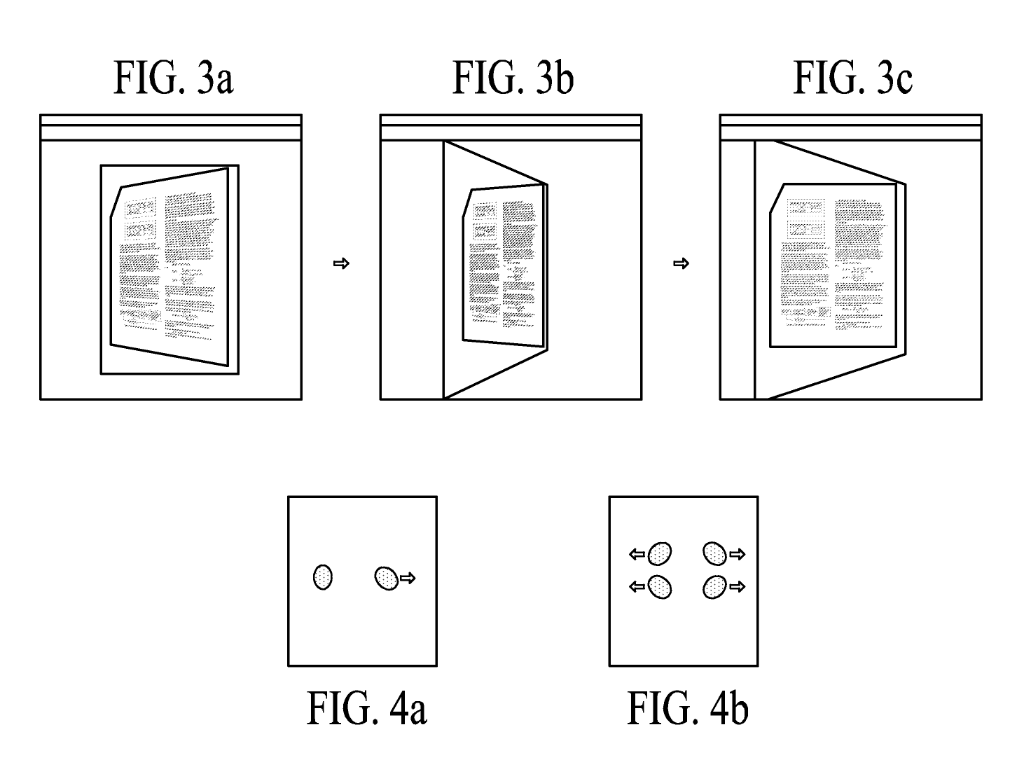

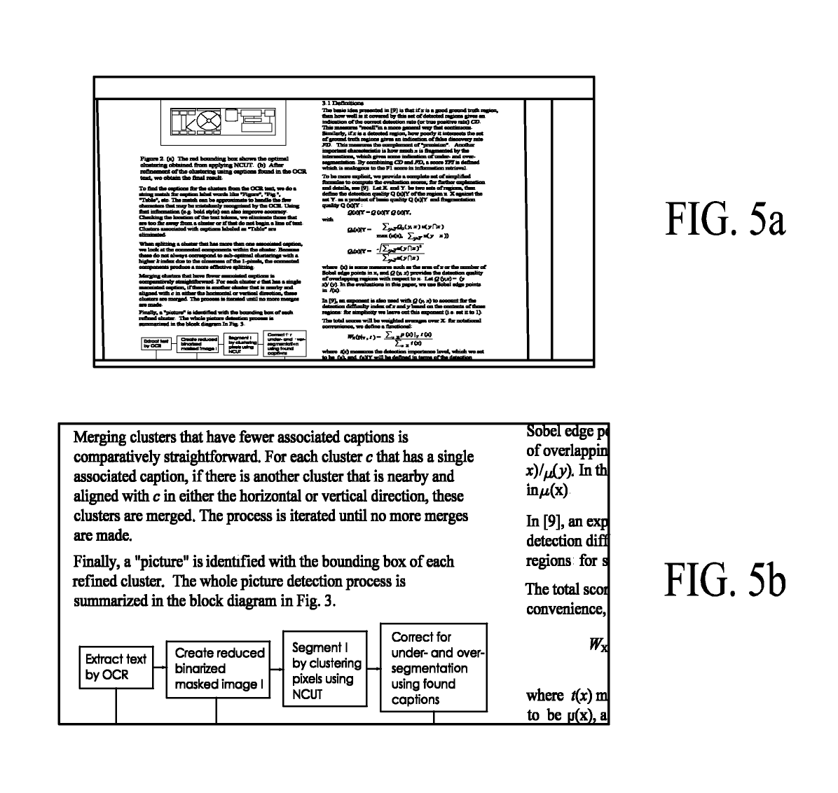

FIG. 3a-3c illustrate rectification of a photo object in accordance with an exemplary embodiment. To perform the rectification, the photo object is first rotated in the 3D view port so that the contents on the document are straightened out, as shown in the transition from rotating FIG. 3a to reach the orientation of FIG. 3b. If the edges of the document are visible in the photo, these will appear to be parallel after the rotation operation, as shown in FIGS. 3a and 3b.

FIGS. 4a and 4b illustrate exemplary gestures that can be used to perform the rectification of FIGS. 3a to 3b in accordance with an exemplary embodiment. At FIG. 4a, an exemplary multi-touch gesture for doing the rotation is illustrated. In this example, the user touches the photo object with one finger and holds it there, while a second finger (on the other hand) drags left or right to perform a rotation about the vertical axis.

A side effect of the rotation operation is that the content on the document is oftentimes compressed horizontally, as shown in FIG. 3b. To fix this, the user can perform a stretch (scaling along one dimension) to fix the compression, as shown in the transition from FIG. 3b to FIG. 3c. An exemplary multi-touch gesture for stretching is to use four contact points (two from each hand) as shown in FIG. 4b. If the hardware can only support two contact points, one way to perform a stretch gesture is to provide a button on the toolbar (see 201 of FIG. 2) to give an alternate interpretation of the gesture in which the two contact points move away or toward each other (the usual non-alternate interpretation is a Pinch or scale gesture).

FIGS. 5a and 5b illustrates scaling up a document image within the 3D viewport to make it readable in accordance with an exemplary embodiment. The document image can be scaled up to make it readable as shown in FIG. 5a. The scaling operation can be performed, for example, with a gesture such as a pinch gesture, and a detailed section of the scaled up document can also be shown, as illustrated FIG. 5b. The result is oftentimes legible, especially when taken into account that no image processing for cleanup has been performed.

Next, the user might want to scroll around on the page by using the familiar scroll bars around the viewport, or equivalently by touching and dragging the page around.

An alternative approach is to employ both a 2D viewport and a 3D viewport, where the 3D viewport is a special mode that the user enters to perform perspective correction and to create a new image for viewing, which can then be viewed back in the 2D viewport. However, there are several disadvantages such as more complexity for the user in terms of multiple UI metaphors, requiring modes, and taking up more memory with the generated images. A more technical problem is that on some platforms (e.g. WINDOWS 7), the rendering pipeline to produce the nice transformed image on the display, which leverages specialized graphics hardware such as the graphical processing unit (GPU), is different from the software rendering pipeline for processing bitmaps, and the results of the latter exhibit a noticeable decrease in image quality (such as poorer anti-aliasing).

Scrolling in the 3D scene under perspective rendering leads to some problems in 3D graphics. Examples in vertical scrolling are described below. For reference, the standard convention to describe the coordinates in 3D graphics is that the x-axis points to the right, the y-axis points up, and the z-axis points outward from the screen.

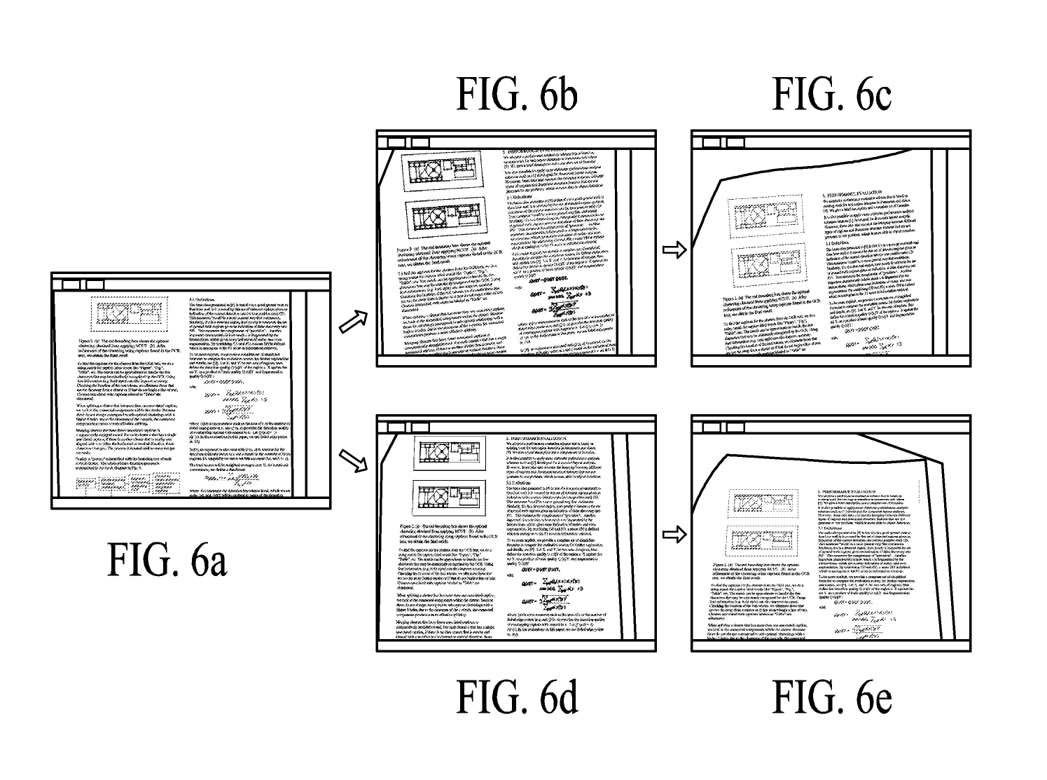

FIGS. 6a to 6e illustrate a comparison of skewing when an image is scrolled vertically versus correcting for the skewing in accordance with an exemplary embodiment.

Referring to FIG. 6, starting with a rectified image as shown in FIG. 6a, that has been rotated about the vertical axis (y-axis) by some angle θ, scrolling it will lead to skewing; as shown as FIG. 6a is scrolled upwards to FIG. 6b and scrolled upwards again to FIG. 6c. This skewing can be corrected by a rotation about the horizontal axis (x-axis) by another angle ψ; as shown as FIG. 6a is scrolled upwards with the correction to FIG. 6d and scrolled upwards again to FIG. 6e. This rotation angle ψ varies for different scroll values dy, and the relationship between them is not a simple one.

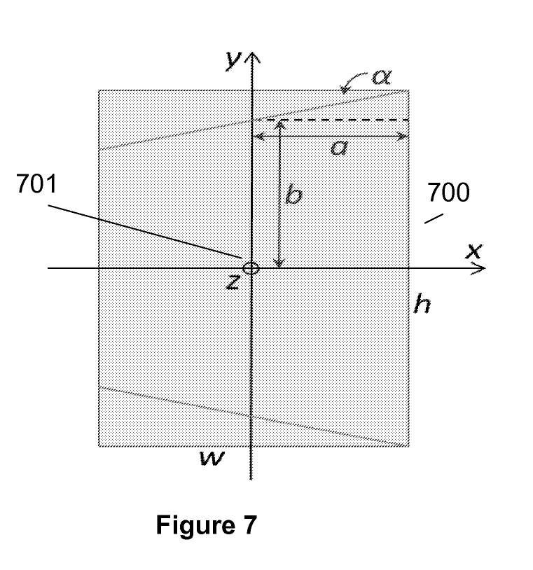

An approach according to an exemplary embodiment to compute the angle ψ for a given scroll value dy and angle θ is first to figure out an equation for them. This will lead to terms involving sines and cosines of these angles, but the formulas do not appear to reduce to a simple expression for ψ. A numerical method such as Newton's Method can be applied, since the sine and cosine functions can be differentiated. FIG. 7 illustrates the photo object of FIG. 3a placed on a center of origin of a coordinate plane in accordance with an exemplary embodiment. First, the photo object 700 of width w and height h is placed in the scene at the origin (0, 0, 0) as shown in 701 of FIG. 7, which corresponds to the scene in FIG. 3a.

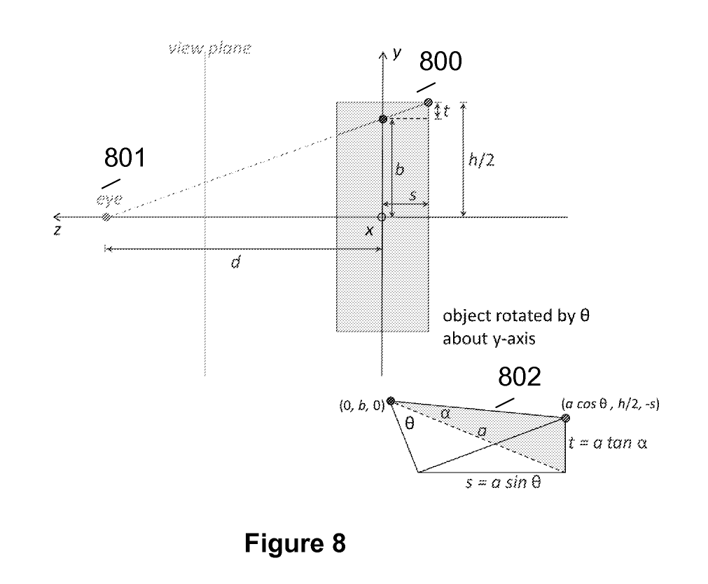

FIG. 8 illustrates a side view of a photo object 800 rotated by angle θ about the y-axis in accordance with an exemplary embodiment. Initially, let the eye or perspective camera be placed at (0, 0, d) as shown in 801, and the view plane at a fixed position parallel to the xy-plane. When the user rotates the object by angle θ to rectify the contents on the document as shown in 802, there will be an angle a such that the line extending from the top right corner with this interior angle will be projected onto the view plane as a horizontal line.

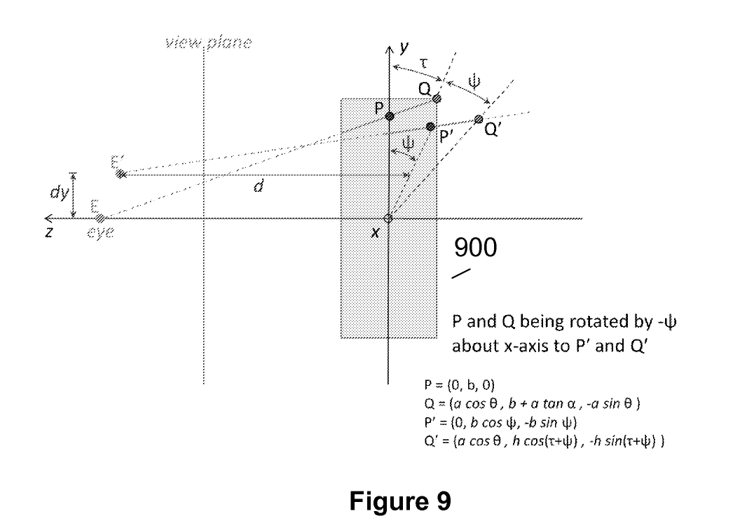

FIG. 9 illustrates a side view of a photo object 900 which has been rotated by angle θ about the y-axis, and to be rotated by angle −ψ about the x-axis, in accordance with an exemplary embodiment. The rotation angle of magnitude ψ is computed for the scroll correction, given the parameters a, b, α, and scroll distance dy, as shown in FIG. 9. The angle ψ must satisfy the condition that the points P′ and Q′ project to the same height in the view plane; or equivalently, from the side view {E′, P′, Q′} are collinear. For the eye to maintain the same distance to the object through the center of the viewport, the lines E′P′ and E′Q′ have the same slope.

Using trigonometry, an expression can be derived in the form:

f(ψ)=0 (1),

where f(ψ) is a polynomial of trigonometric functions of ψ and (τ+ψ), which also involves the parameters b, d, h, dy. The explicit formula is:

ƒ(ψ)=(b cos ψ−dy)[−h sin(τ+ψ)−(d+dy tan ψ)]−(h cos(τ+ψ)−dy)[b sin ψ+(d+dy tan ψ)]=0. (2)

Formula (2) does not reduce to a simple formula for ψ, so f(ψ)=0 should be solved numerically. f(ψ)=0 can be solved numerically by applying an algorithm such as Newton's Method. In order to use Newton's Method, which is an iterative algorithm, the derivative of f′(ψ) is obtained, and an initial estimate ψ 0 of the solution. Then Newton's Method defines an iterative sequence of values {ψ n} by the recurrence equation:

$${ψ}_{n + 1} = {ψ}_{n} - \frac{f ( {ψ}_{n} )}{f ( ( ψ )} \qquad ( 3 )$$

The derivative f′(ψ) can be obtained from f(ψ), given by expression (2) above, using the chain rule from calculus along with the basic formulas for the derivative of the trigonometric functions.

The initial estimate ψ 0 of the solution can be made by taking a rough approximation of FIG. 9.

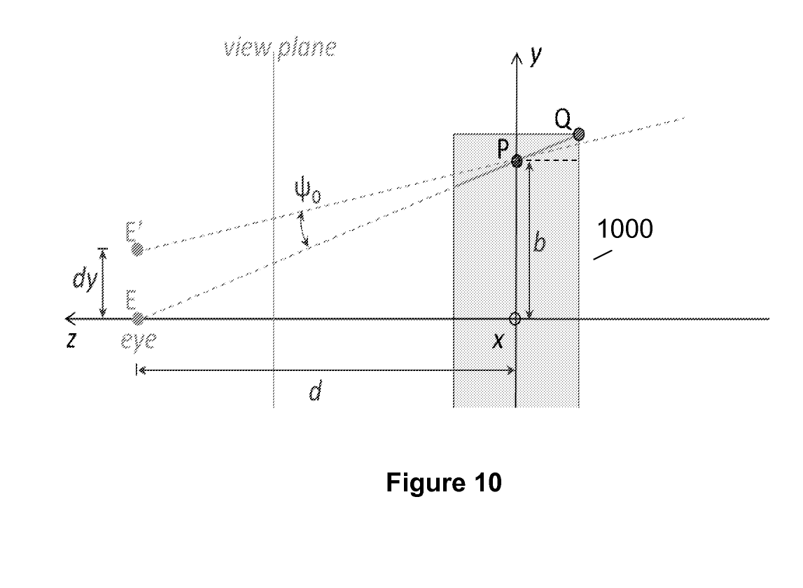

FIG. 10 illustrates parameters for approximating the rotation angle from parameters of the photo object 1000 in accordance with an exemplary embodiment. One way to estimate the angle is shown in FIG. 10, which yields:

$${ψ}_{0} = arctan ( \frac{b}{d} ) - arctan ( \frac{b - dy}{d} ) \qquad ( 4 )$$

In implementations of the exemplary embodiments, the terms are computed until the difference between successive terms is less than ε=0.00001. This requires several hundred iterations, and it runs fast enough for real time interaction as the user clicks the scrollbar repeatedly.

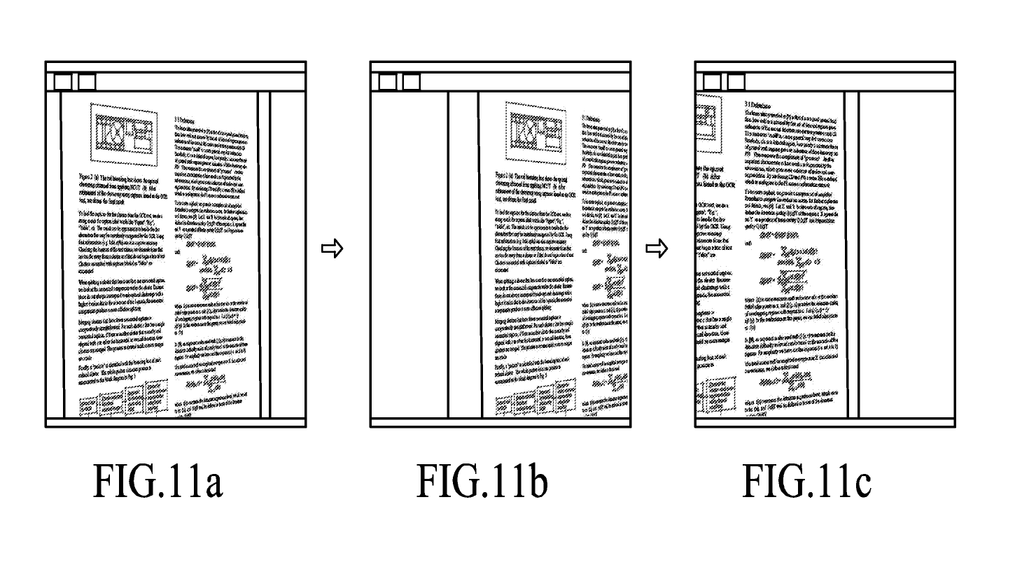

FIGS. 11a to 11c illustrate scrolling an image along the horizontal axis. The image of the document in FIG. 11a is within the three dimensional viewport to the right as shown in FIG. 11b and then to the left as shown in FIG. 11c to determine what type of distortion would occur. Horizontal scrolling turns out to be much simpler than vertical scrolling. The distortion behaves differently than for vertical scrolling and the lack of skewing is unexpected, as shown when the image of FIG. 11a is scrolled to the right as shown in FIG. 11b and scrolled to the left as shown in FIG. 11c.

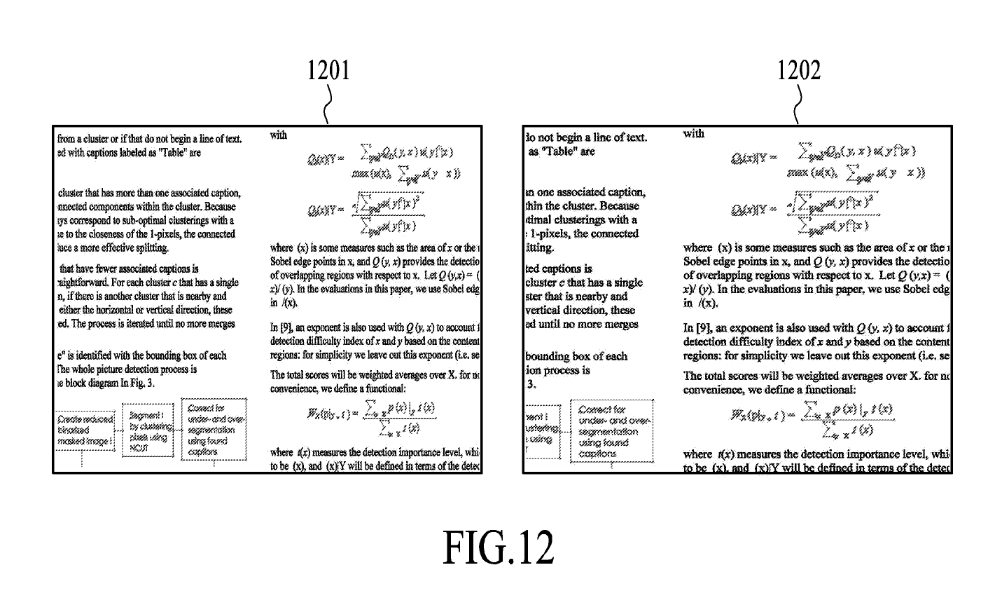

FIG. 12 illustrates stretching that may occur when the image is scrolled horizontally without any correction 1201, and an image with the stretching corrected 1202. The distortion behavior in horizontal scrolling tends to be in the form of horizontal stretching, as shown in 1201.

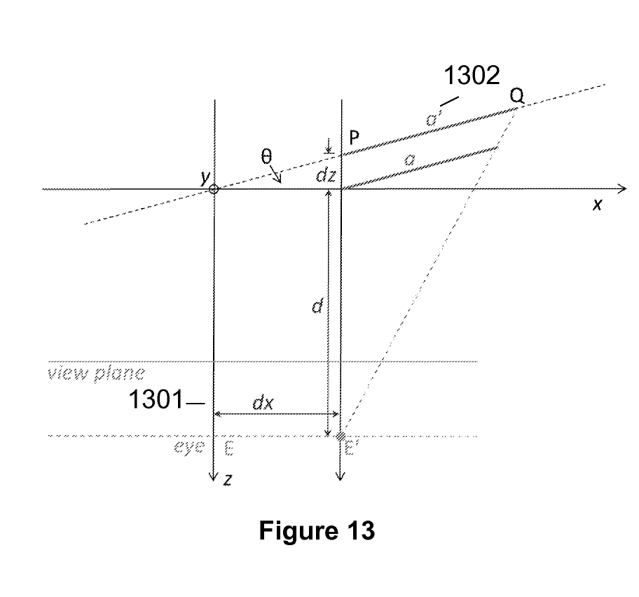

To correct for the stretching shown in 1201 and to reach a correctly rectified image as shown in 1202 of FIG. 12, the top view is first considered as illustrated in FIG. 13.

FIG. 13 illustrates exemplary parameters considered from a top view of a photo object in accordance with an exemplary embodiment. Suppose there is a photo object of width 2a (as shown in FIG. 7), and it has been rotated by θ about the y-axis. If the photo objected is scrolled horizontally by dx 1301, slid in its rotated plane and scaled in width to 2a′ so that the photo object appears to be the same size when projected into the view plane, then the problems that need to be solved are determining a′ 1302 and the scale.

By similar triangles, we have

$$\frac{a}{{a}^{′}} = \frac{d}{d + dz} \qquad ( 5 )$$

Since dz=dx tan θ, the solution is

$${a}^{′} = \frac{a}{d ( d + d x tan θ )} \qquad ( 6 )$$

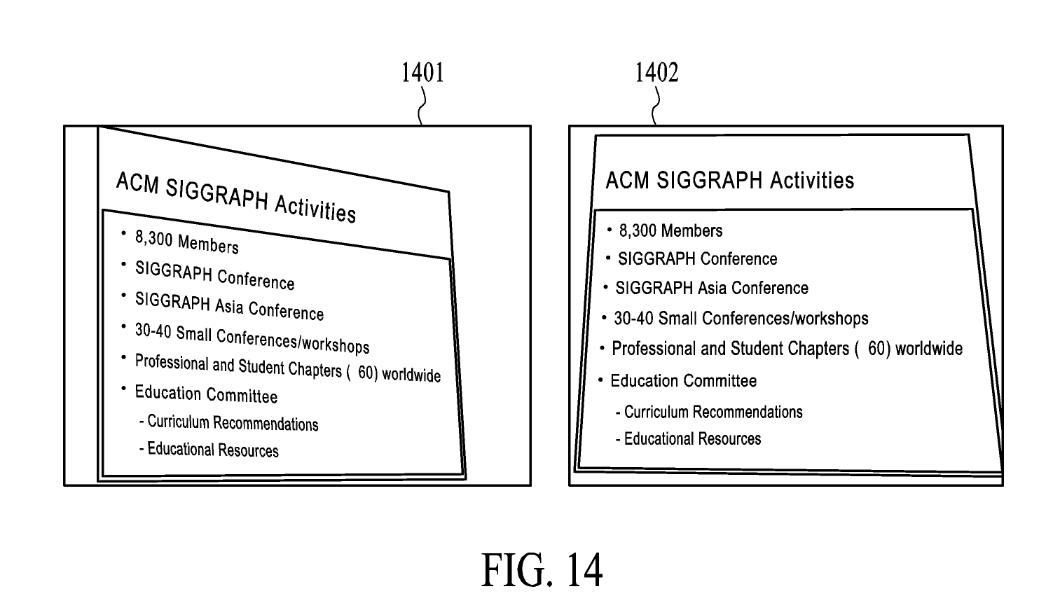

FIG. 14 illustrates photos of slides that have been manipulated according to an exemplary embodiment. A photo of a slide 1401 can be rectified to 1402 as illustrated.

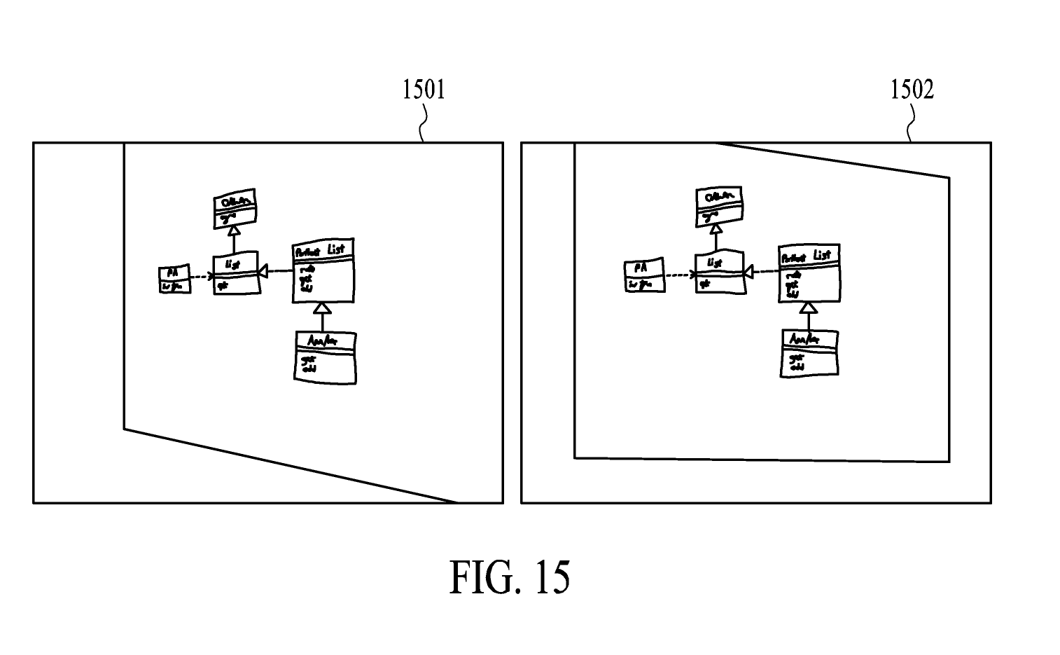

FIG. 15 illustrates photos of a whiteboard that have been manipulated by an implementation of the exemplary embodiments. A photo of a whiteboard 1501 can be rectified 1502 as illustrated.

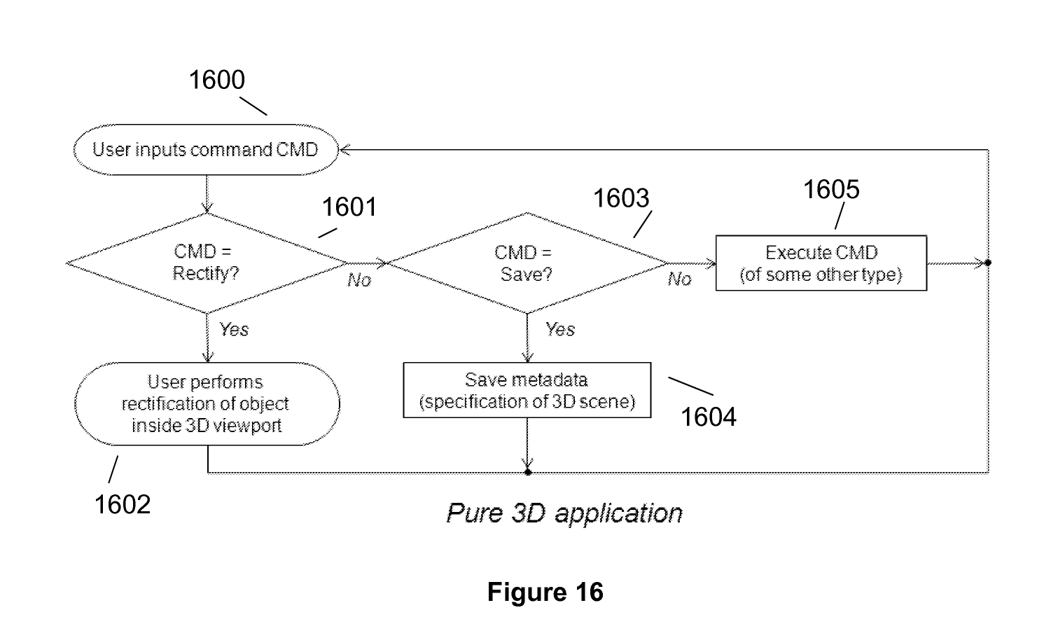

FIG. 16 illustrates a flowchart of pure 3D mode implementation in accordance with an exemplary embodiment. A command may be input by a user 1600 either by a gesture, a multi-touch gesture, or other means. The command is processed to determine if the command is for rectifying the image of the document 1601. If the command is for rectifying the image of the document, then the document is rectified according to the user input 1602. If the command is not for rectification, then another command may be examined and executed instead. For example, the exemplary embodiment may determine if the command is for saving information (such as metadata) regarding the displayed image 1603, and if it is for saving such information, saving the information 1604. If the command is not for saving the information, another command may be processed instead 1605.

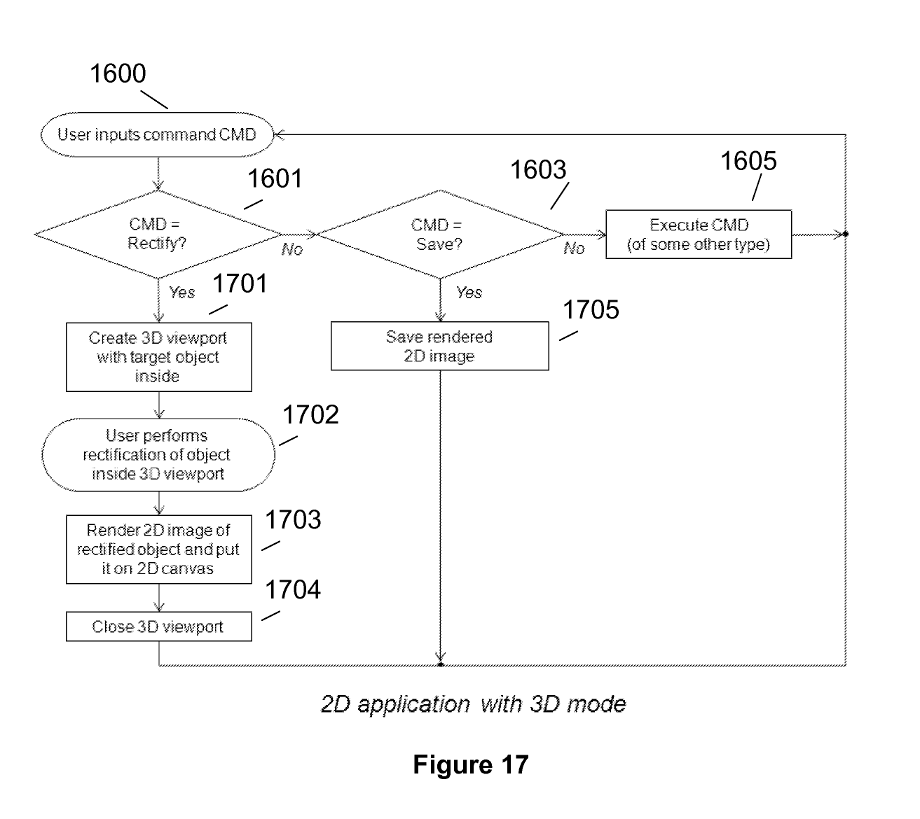

FIG. 17 illustrates a flowchart for rendering a 2D image with a 3D mode implementation in accordance with an exemplary embodiment. The implementation is similar to the pure 3D mode, with some notable differences. If the command is for rectifying the image of the document, a process may be invoked that may involve creating a 3D viewport with the target object inside the viewport 1701. The user may thereby rectify the target object within the 3D viewport 1702. When the user has rectified the target object as desired, a 2D image of the object may be rendered 1703, and the 3D viewport may be exited 1704. The rendered 2D image can subsequently be displayed as the rectified target object. If the command is a save function, the rendered 2D image may be saved 1705 for future reference by the user.

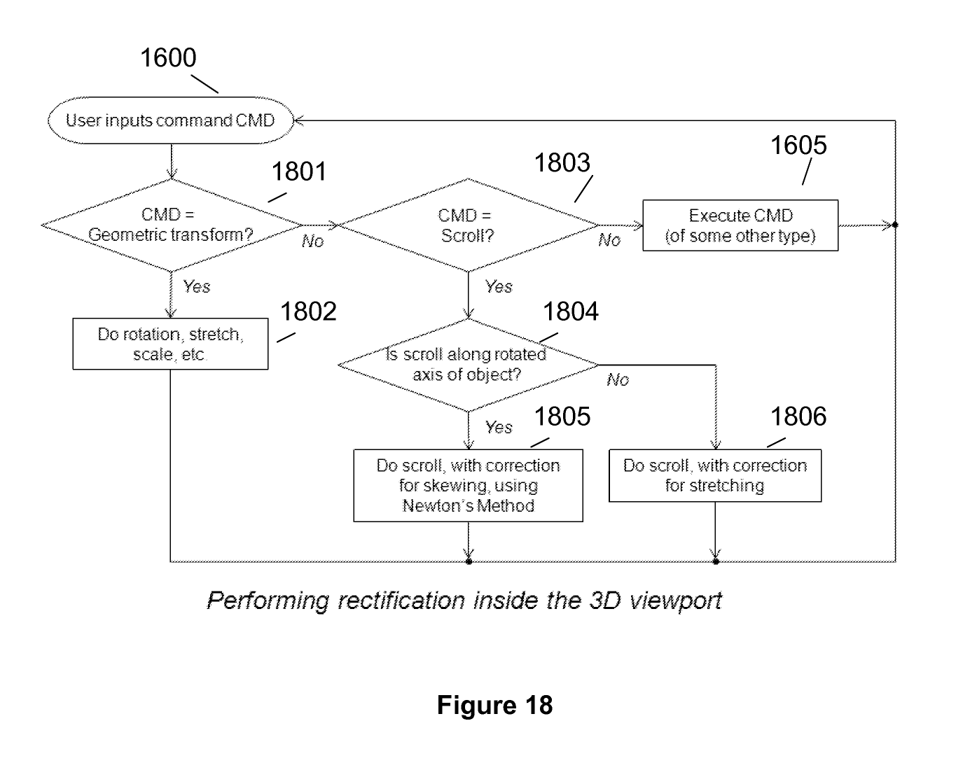

FIG. 18 illustrates a flowchart for rectification of a target object with the 3D viewport in accordance with an exemplary embodiment. Within the 3D viewport, the command may be analyzed to determine if it is a geometric transform 1801, a scroll 1803 or another command 1605. If the command is for a geometric transform of the target object, then an appropriate geometric transform (e.g. rotate, stretch, scale, etc.) may be performed 1802. If the command is for scrolling the target object 1803, then the scroll command may be analyzed to check if the scroll is along the rotated axis of the object 1804. When the scrolling is along the rotated axis of the object (such as being orthogonal to the rotated axis), then the scrolling may be performed with correction for skewing 1805, which may be conducted by utilizing Newton's Method. When the scrolling is not along the rotated axis of the object, then the scrolling may be performed with correction for stretching 1806. Alternatively, corrections for both stretching and skewing may be performed if the scrolling is neither orthogonal to the rotated axis of the target object, nor along the rotated axis.

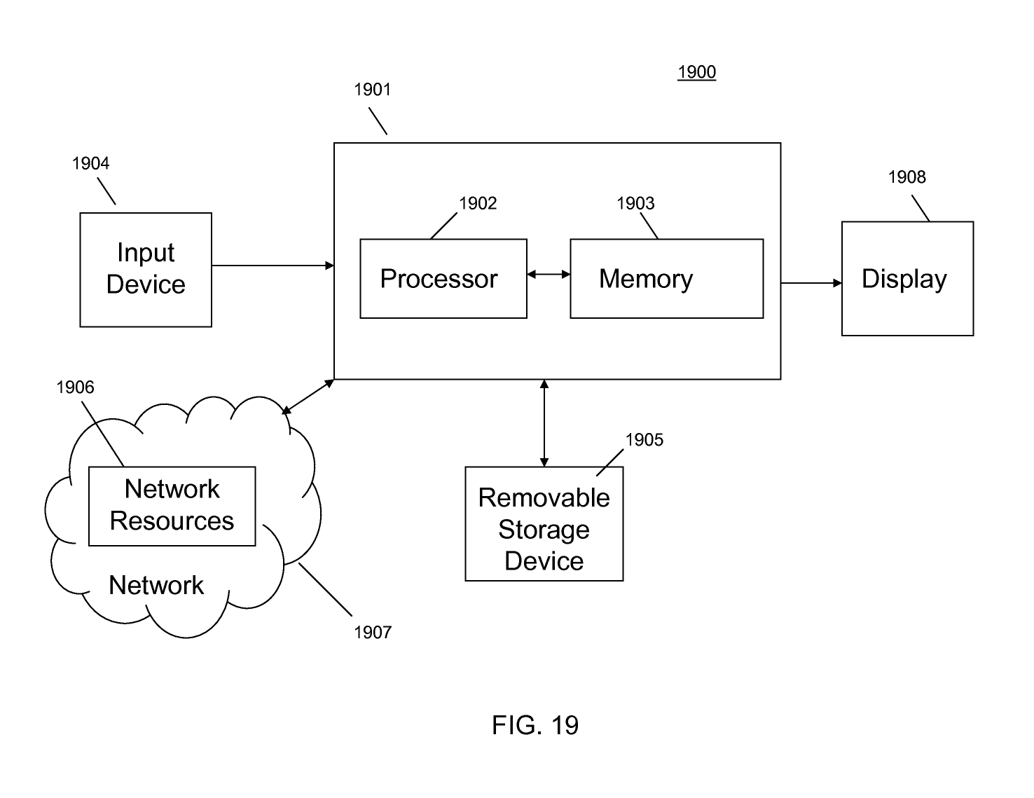

FIG. 19 is a block diagram that illustrates an embodiment of a computer/server system 1900 upon which an embodiment of the inventive methodology may be implemented. The system 1900 includes a computer/server platform 1901 including a processor 1902 and memory 1903 which operate to execute instructions, as known to one of skill in the art. The term “computer-readable medium” as used herein refers to any medium that participates in providing instructions to processor 1902 for execution. Additionally, the computer platform 1901 receives input from a plurality of input devices 1904, such as a keyboard, mouse, touch device, multi-touch device, or verbal command. The computer platform 1901 may additionally be connected to a removable storage device 1905, such as a portable hard drive, optical media (CD or DVD), disk media or any other medium from which a computer can read executable code. The computer platform may further be connected to network resources 1906 which connect to the Internet or other components of a local public or private network. The network resources 1906 may provide instructions and data to the computer platform from a remote location on a network 1907. The connections to the network resources 1906 may be via wireless protocols, such as the 802.11 standards, Bluetooth® or cellular protocols, or via physical transmission media, such as cables or fiber optics. The network resources may include storage devices for storing data and executable instructions at a location separate from the computer platform 1901. The computer interacts with a display 1908 to output data and other information to a user, as well as to request additional instructions and input from the user. The display 1908 may therefore further act as an input device 1904 for interacting with a user.

Moreover, other implementations of the invention will be apparent to those skilled in the art from consideration of the specification and practice of the invention disclosed herein. Various aspects and/or components of the described embodiments may be used singly or in any combination in the image identification system. It is intended that the specification and examples be considered as exemplary only, with a true scope and spirit of the invention being indicated by the following claims.

What is claimed is:

1. A method of manipulating an image containing a document, comprising:
creating a three dimensional viewport for the image;
upon receipt of a gesture for rectifying the image, rectifying the image according to the gesture;
wherein the gesture is received directly on the image within the three dimensional viewport.

2. The method of claim 1, further comprising rendering the rectified image into a two dimensional image and displaying the image on a two dimensional viewport.

3. The method of claim 1, wherein if the gesture for the rectifying is a command for rotating or stretching the image, performing the rotating or stretching according to the gesture.

4. The method of claim 1, wherein if the gesture for the rectifying is a command for scrolling the image, determining if the scrolling is along a rotated axis of the image.

5. The method of claim 4, wherein if the scrolling is along the rotated axis of the image, scrolling the image according to the gesture and correcting for skew by utilizing a numerical algorithm to solve for a geometric transform.

6. The method if claim 4, wherein if the scrolling is not along the rotated axis of the image, scrolling the image according to the gesture and correcting for stretching of the image based on the scroll.

7. A method of manipulating an image of a document, comprising:
creating a three dimensional viewport for the image of the document;
receiving a command;
wherein if the command is for scrolling the image, scrolling the image according to the gesture and correcting for geometric distortion by utilizing a numerical algorithm to solve for a geometric transform during the scrolling.

8. The method of claim 7, wherein when the command is for dragging the image, dragging the image according to the gesture and correcting for geometric distortion during the dragging.

9. The method of claim 7, wherein the correcting for geometric distortion comprises correcting for skew by applying a numerical algorithm to solve for a geometric transform when the scrolling is along a rotated axis of the image.

10. The method of claim 7, wherein the correcting for geometric distortion comprises correcting for stretching of the image based on the scroll when the scrolling is orthogonal to the rotated axis of the image.

11. The method of claim 7, wherein the correcting for geometric distortion comprises correcting for stretching and correcting for skew when the scrolling is not orthogonal or along the rotated axis.

12. The method of claim 11, wherein the correcting for skew comprises utilizing Newton's Method.

13. An apparatus, comprising:
a touch display operable to display an image of a document in a three dimensional viewport;
a manipulation module, wherein upon receipt of a gesture directly on the image displayed within the three dimensional viewport on the touch display, the manipulation module manipulates the image according to the gesture; and
a correction module correcting the image for geometric distortion caused by a scroll, drag or rotation of the image resulting from the manipulation of the image.

14. The apparatus of claim 13, further comprising a rendering module for rendering the rectified image into a two dimensional image and
wherein the touch display is operable to display the two dimensional image in a two dimensional viewport.

15. The apparatus of claim 13,
wherein the correction module corrects for geometric distortion by correcting for stretching of the image based on the scroll when the scroll is orthogonal to a rotated axis of the image.

16. The apparatus of claim 13,
wherein the correction module corrects for geometric distortion by applying a numerical algorithm to solve for a geometric transform when the scroll is along a rotated axis of the image to correct for skew.

17. The apparatus of claim 13, wherein the correction module corrects for geometric distortion by correcting for stretching and correcting for skew when the scrolling is not orthogonal or along the rotated axis.

18. The apparatus of claim 13, wherein the manipulation module manipulates the image by rotating the image upon receipt of the gesture comprising a multi-touch gesture, the multi-touch gesture comprising a first touch directly on the image for holding the image in place and a second touch rotating the image.

19. The apparatus of claim 13, wherein the manipulation module manipulates the image by scaling the image along a dimension upon receipt of the gesture comprising a multi-touch gesture, the multi-touch gesture comprising a four touches directly on the image for stretching the image to scale the image along a dimension.
